(19) United States
(12) Patent Application Publication
(10) Pub. No.: US 2026/0351059 A1
(43) Pub. Date: Nov. 5, 2026

(54) ADAPTIVE META-LOCKS AND META-KEYS IN A NETWORK ENVIRONMENT

(71) Applicant: International Business Machines Corporation, Armonk, NY (US)

(72) Inventors: Steven Lee Fisher-Stawinski, Buffalo Grove, IL (US); Sophie Batchelder, Cambridge, MA (US); Scott E. Schneider, Rolesville, NC (US); THOMAS TAHAN, San Diego, CA (US); Manana Hakobyan, San Jose, CA (US)

(73) Assignee: International Business Machines Corporation, Armonk, NY (US)

(21) Appl. No.: 19/195,834

(22) Filed: May 1, 2025

(51) Int. Cl. G07C 9/00

(52) U.S. Cl. CPC G07C 9/00309; G07C 2009/00325

(57) ABSTRACT

An embodiment includes responsive to receiving, by a server, an authorization request from a user of a user device, for unlocking a meta-lock, authenticating, by the server, the user for authorization to unlock the meta-lock. The embodiment includes where the authorization request includes a key configuration of a pre-existing key. The embodiment includes generating, by the server, a key configuration. The embodiment includes generating, by the server, a pinning configuration based on the key configuration. The embodiment includes adopting, by the meta-lock, the generated pinning configuration.

### BACKGROUND

The present invention relates generally to physical access security. More particularly, the present invention relates to a method, system, and computer program for Adaptive Meta-locks and Meta-keys In a Network Environment.

Physical security is a critical component of an overall security strategy. Physical locks are ubiquitous in everyday life, and throughout human history have secured immovable properties such as private residences, offices, commercial buildings and personal properties. During the Middle Ages, advancements in metalworking led to the development of more complex locks. These locks required keys with specific notch patterns to turn freely and disengage the bolt. The introduction of the pin tumbler lock in the 19th century was a major step forward in lock technology. This lock used a flat key with ridges of various heights to align a set of pins within the lock, allowing the barrel to be turned.

Today, most locks are based on the principles of the Yale pin tumbler lock, with some advanced techniques like magnetic keys and anti-pick technology being used. Smart locks and keyless entry systems are also becoming increasingly popular. A smart lock is an electronic lock that can be operated remotely, typically via a smartphone app, and often uses keyless entry methods like a keypad or fingerprint scanner. Unlike traditional locks that require a physical key, smart locks offer keyless entry, remote control, and enhanced security features.

### SUMMARY

The illustrative embodiments provide for Adaptive Meta-locks and Meta-keys In a Network Environment. An embodiment includes responsive to receiving, by a server, an authorization request from a user of a user device for unlocking a meta-lock. The embodiment includes authenticating, by the server, the user for authorization to unlock the meta-lock. The embodiment includes generating, by the server, a key configuration. The embodiment includes generating, by the server, a pinning configuration based on the key configuration. The embodiment also includes adopting, by the meta-lock, the generated pinning configuration.

An embodiment includes responsive to receiving, by a server, an authorization request from a user of a user device for unlocking a meta-lock wherein the authorization request includes a key configuration of a pre-existing key. The embodiment includes authenticating, by the server, the user for authorization to unlock the meta-lock. The embodiment includes generating, by the server, a pinning configuration based on the key configuration. The embodiment includes adopting, by the meta-lock, the generated pinning configuration.

An embodiment includes a system. The system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2A depicts a diagram of a lock server in communication with a user device, key configuration device, meta-key and meta-lock in accordance with an illustrative embodiment;

FIG. 2B depicts a diagram of a lock server in communication with a user device, key configuration device, a pre-existing key and a meta-lock in accordance with an illustrative embodiment;

FIG. 3 depicts a diagram of a cross-section of a segmented pin of a meta-lock in accordance with an illustrative embodiment;

FIG. 4A depicts diagrams of a top view of a plate and bottom view of a plate of a meta-lock in accordance with an illustrative embodiment;

FIG. 4B depicts diagrams of side views of a plate of a meta-lock in accordance with an illustrative embodiment;

FIG. 5 depicts flow chart for configuring adaptive meta-locks and meta-keys in a network environment in accordance with an illustrative embodiment; and

FIG. 6 depicts a system diagram for configuring adaptive meta-locks and meta-keys in a network environment in an environment in accordance with an illustrative embodiment.

### DETAILED DESCRIPTION

Many consumers still prefer physical keys primarily because of their simpler operation, reliance on tangible manipulation, and historical precedent. A physical key provides a direct and easily understood interaction with the lock's mechanism, while digital systems introduce the potential for complexity, vulnerability to technical glitches, and reliance on external factors like power and internet access.

However, physical keys are commonly lost and electric locks run the risk of dead batteries. Classic locks with physical keys can be picked and broken into. Specifically, physical security keys, such as those used for online services or access control, present several challenges. These include the possibility of loss, theft, or unauthorized duplication, which can compromise security. Additionally, physical keys can be cumbersome to manage and distribute, leading to inefficiencies and potential security risks. Physical keys require manual management, which can be inefficient and prone to errors. Issuing and tracking keys across a large organization can be complex and resource intensive.

Currently there is no way to enable adaptive physical locks and keys in a network technically feasible manner, which can protect users with increased convenience. There is also currently no holistic system that considers people, systems, contexts, and ecosystems. These current limitations make it impossible to provide efficient, cost-effective and adaptive physical locks and keys to end users. As a result, current efforts in this regard are inefficient and ineffective due to the current inability to enable adaptive physical locks and keys in a network environment.

The present disclosure addresses the deficiencies described above by providing a process (as well as a system, method, machine-readable medium, etc.) that authenticates, generates a pinning configuration by the lock configuration component, executes specially purposed instructions and leverages recent advances in physical security and computing to provide adaptive physical locks and keys in a network environment.

The illustrative embodiments provide for Adaptive Meta-locks and Meta-keys In a Network Environment. As used herein, the term “server” may refer to a computing device running software or a software component, and the term “adaptive” may refer to the ability to change based on changes in configurations. As used herein “physical” may refer to a tangible or concrete object. As used herein “meta-lock” may refer to a physical lock where the physical lock is an advanced type of key. As used herein “meta-key” may refer to a physical key to unlock a physical lock where the physical key is an advanced type of key. As used herein “instruction” may refer to a software, firmware, or hardware component.

Illustrative embodiments include responsive to receiving, by a server, an authorization request from a user of a user device for unlocking a meta-lock; authenticating, by the server, the user for authorization to unlock the meta-lock. In some embodiments, the authorization request includes a key configuration of a pre-existing key. As used herein, the term “authenticating” may refer to executing computer instructions in the verification of a user's identity, confirming they are who they claim to be, before granting them access to a meta-lock and/or meta-key to unlock a meta-lock.

Illustrative embodiments include generating, by the server, a key configuration.

Illustrative embodiments include generating, by the server, a pinning configuration based on the key configuration.

As used herein, the term “pinning” may refer to a lock mechanism such as in a pin tumbler lock that enables a lock to be locked and/or unlocked.

Illustrative embodiments include adopting, by the meta-lock, the generated pinning configuration.

Illustrative embodiments include further comprising causing, by the user device, a physical meta-key to be configured according to the key configuration such that the physical meta-key is configured to unlock the meta-lock. Illustrative embodiments include where the server receives from the user, the key configuration of a pre-existing key, causing the meta-lock to adopt the generated pinning configuration based on the key configuration of the pre-existing key.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

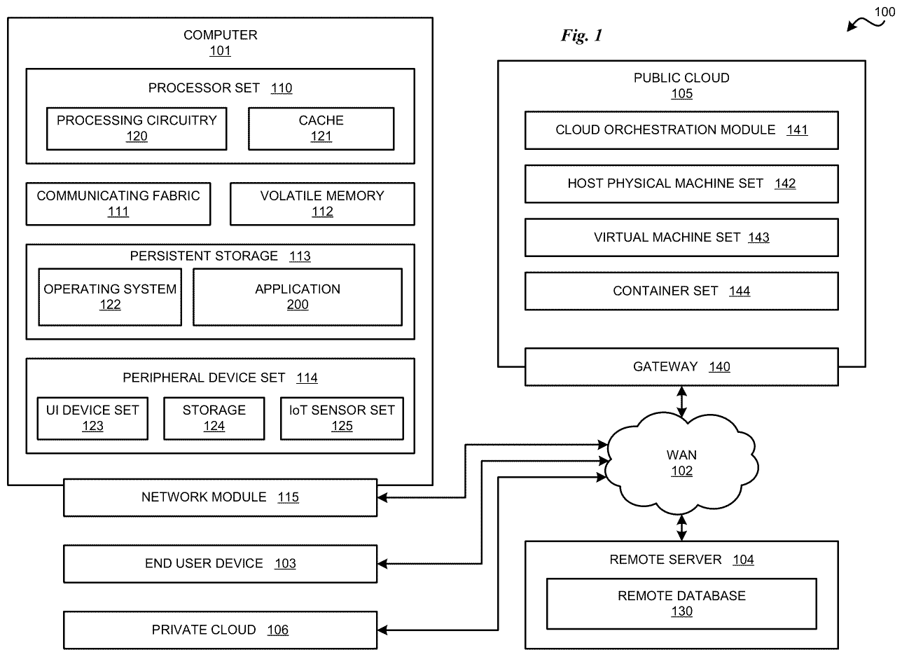

With reference to FIG. 1, this figure depicts a block diagram of a computing environment 100. Data center environment 100 contains an example of an environment for the execution of at least some of the computer code involved in performing the inventive methods, such as an Application 200 that provides Adaptive Meta-locks and Meta-keys In a Network Environment. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made. Available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of Application Programming Interfaces (API). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

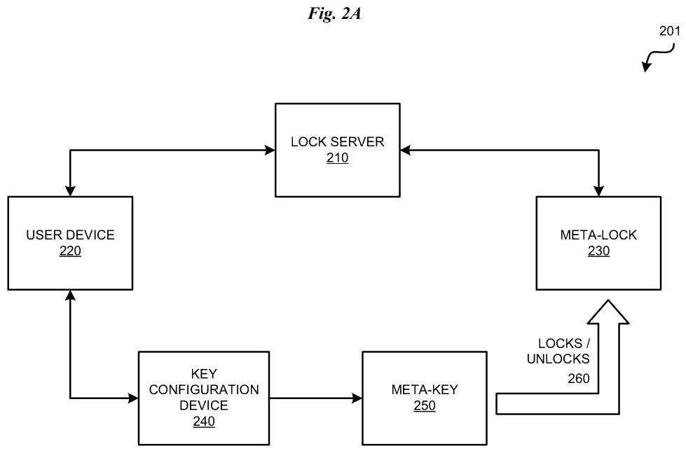

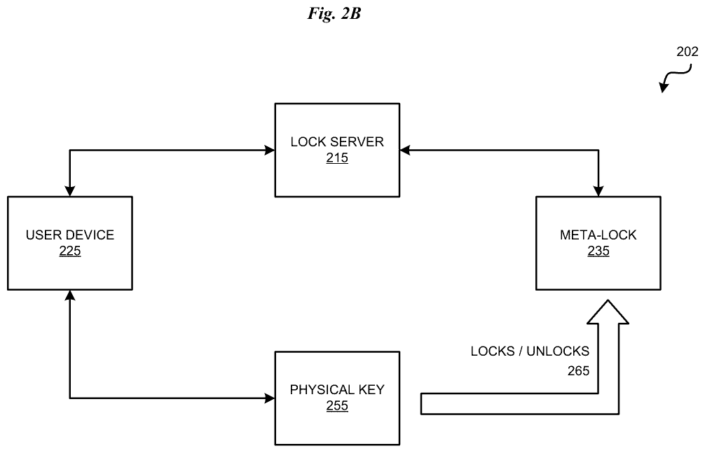

FIG. 2A depicts a diagram of a lock server in communication with a user device, a key configuration device, a meta-key and a meta-lock in accordance with an illustrative embodiment. In a particular embodiment, the components of the diagram 201 show aspects of the Application 200 of FIG. 1.

In the illustrated embodiment, a lock server 210 receives an authorization request from a user of a user device 220. An authentication component of the server executes a specially purposed authentication instruction authenticating the user for authorization to unlock a physical meta-lock 230. For example, the lock server 210 may receive an authorization request in a format including but not limited to binary, Extensible Markup Language (XML), and/or structured or unstructured formats according to network communications standards such as Transmission Control Protocol/Internet Protocol (TCP/IP) internet protocols. In an example, the lock server sends to the meta-lock a specially purposed pinning instruction, executing the specially purposed pinning instruction by the meta-lock causes the meta-lock to adopt the generated pinning configuration. In another example, the server sends to the user device a specially purposed user instruction, where executing the specially purposed user instruction by the user device causes a physical meta-key 250 to be configured by a key configuration device 240 according to the pinning configuration.

In various embodiments, the server operates in-whole or in-part from one or more processors embedded in the meta-lock, or in-whole or in-part from one or more remotely located processors, cloud services, or virtual machines; in such embodiments, the lock configuration component may be deemed to be part of the server, regardless of the particular network architecture of the embodiment.

In some embodiments, a key configuration component of the lock server may execute a specially purposed key configuration instruction to generate a key configuration. A key configuration may comprise configuration information of a meta-key. Based on the key configuration, a lock configuration component of the server may execute a specially purposed lock instruction to generate a pinning configuration. In an example, the pinning configuration is generated based on a random generator such that the plates of the meta-lock are aligned based on random numbers.

In other embodiments, a key configuration comprises an image of a key. For example, an image of a pre-existing key may be captured by a camera, scanned or retrieved from a data store. In an example, an image of an existing key is captured, scanned or retrieved. In another example, an image is captured, scanned or retrieved of a partially cut key. In such examples, converting the image from a format such as Joint Photographic Experts Group (JPEG), Portable Network Graphics (PNG), Graphics Interchange Format (GIF) to binary representations. The binary representations of the physical key are processed by a key configuration component that executes a specially purposed key configuration instruction to generate a key configuration.

In embodiments, a specially purposed pinning instruction is executed by a lock configuration component of the server to generate, based on the key configuration, a pinning configuration that enables the key to unlock the meta-lock. To determine the pinning configuration, the specially purposed lock instruction may generate a specially purposed pinning instruction for the components of the meta-lock that causes the meta-lock to adopt the generated pinning configuration. In some embodiments, a pinning configuration may be adopted by multiple meta-locks and/or meta-keys such that to enable a meta-key to open multiple meta-locks in a facility.

In an embodiment, a key configuration device 240 receives via Bluetooth, Near Field Communications (NFC), wired communication, or other communications mechanisms an instruction to configure a physical meta-key 250 according to a key configuration from a user device. For example, the key configuration device may be a 3D pen such as a variation of a 3D “doodler” or printing pen that can resin-print a key on the fly. A 3D pen works by extruding heated plastic that cools almost instantly into a solid, stable structure, allowing for the free-hand creation of three-dimensional objects. It may utilize a plastic thread or other injectable or moldable material. In another example, the key configuration device may be a variation of 3D “doodler” that can inject resin into a mechanically variable mold. In yet another example, the key configuration device may configure a variable meta-key with mechanical structures that raise/lower from a key blank.

In another embodiment, a key configuration device 240 may receive a key configuration and responsive to the key configuration mechanically engage a key blank to produce a meta-key. For example, a key blank is a template made of materials such as brass, nickel silver, steel, or a reusable material that may be cut and shaped to match a particular key configuration. A key configuration device may execute a specially purposed key configuration instruction to mechanically engage to cut, mold, manipulate and/or transform a key blank into a meta-key. In some examples, a previously configured meta-key may be cut, molded, manipulated and/or transformed into a new meta-data. A key configuration device 240 may be a locksmith device, a 3D pen and/or similar devices cut, mold, manipulate and/or transform a key blank into physical meta-key 250. The meta-key is then enabled to lock/unlock 260 the physical meta-lock 230.

An example use case is provided below:

| | |
|---|---|
| 1 | User 1 owns a condo in a city three hours away from her primary residence. |
| 2 | User 1 is notified by a neighbor that he heard her smoke detector chirping due |
| | to a low battery all weekend. |
| 3 | To avoid the six hours round trip to replace the battery, User 1 asks her |
| | neighbor to enter her condo to change the battery. |
| 4 | User 1 provides her neighbor with temporary access to her condo by asking |
| | the front desk of the building to give her neighbor a meta-key. |
| 5 | As the neighbor goes to unlock the condo, the lock server a specially purposed |
| | pinning instruction to the door lock configuring the door meta-lock and the |
| | meta-key to allow access to the condo. |
| 6 | After the neighbor's visit to the condo, because of the settings on the meta- |
| | lock, and the type of meta-key, the meta-lock is automatically configured |
| | back to match User 1's key and the temporary meta-key no longer unlocks |
| | the meta-lock of the condo. |

FIG. 2B depicts a diagram of a lock server in communication with a user device, key configuration device, a pre-existing key and a meta-lock in accordance with an illustrative embodiment. In a particular embodiment, the components of the diagram 202 show aspects of the Application 200 of FIG. 1.

In the illustrated embodiment, responsive to receiving the request, a lock server 215 authenticates the user of a user device 225 for authorization to unlock a meta-lock 235. The user may be authenticated by known methods such as a password manager, magic links, passkey, an unlock code, and/or biometrics, etc. In an example, authenticating the user comprises an authenticating method selected from a location requirement of the user device, a biometric requirement of the user, a software passkey operated on the user device, a one-time authentication code, and a security key fob in communication with the user device.

In other embodiments, the lock server receives a key configuration of a pre-existing key 255 from the user of the user device. For example, a key configuration of a pre-existing key may be received by the lock server as a representation of a pre-existing key. For instance, an image of a pre-existing key may be captured by a camera, scanned or retrieved from a data store. In an example, an image of an existing cut physical key is captured, scanned or retrieved. In another example, an image is captured, scanned or retrieved of a partially cut physical key. In such examples, a specially purposed key configuration instruction is executed by a key configuration component of the server converting the image from a format such as Joint Photographic Experts Group (JPEG), Portable Network Graphics (PNG), Graphics Interchange Format (GIF) to binary representations. The binary representations of the physical key are processed, and a key configuration is generated.

Based on the key configuration, a specially purposed lock configuration instruction is executed by a lock configuration component and a pinning configuration that enables the key to lock and/or unlock 265 the meta-lock is generated. To determine the pinning configuration, the specially purposed lock instruction may generate a specially purposed pinning instruction for the components of the meta-lock that causes the meta-lock to adopt the generated pinning configuration. In some embodiments, a pinning configuration may be adopted by multiple meta-locks and/or meta-keys such that to enable a meta-key to open multiple meta-locks in a facility.

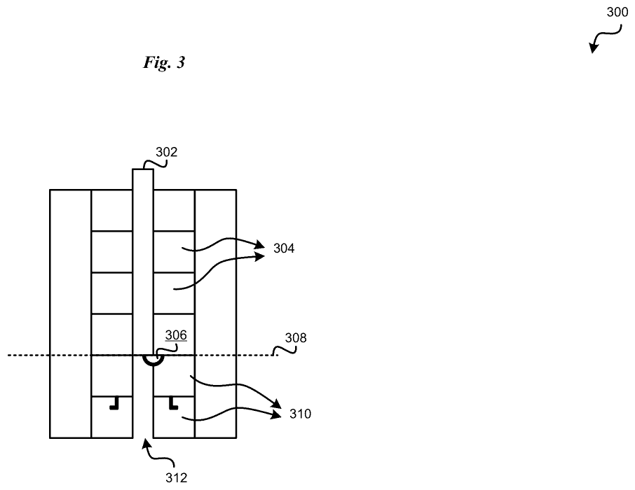

FIG. 3 depicts a diagram of a cross-section of a segmented pin of a meta-lock in accordance with an illustrative embodiment. In a particular embodiment, the components of the diagram 300 show aspects of the Application 200 of FIG. 1.

In the illustrated embodiment, a cross-section of a segmented pin of a meta-lock 300 such as viewed from the key side is depicted. In embodiments, the meta-lock may be a pin-tumbler lock. For example, a pin-tumbler lock is a type of lock that comprises a pin mechanism where pins of varying lengths to secure a rotating plug, also known as a cylinder. When a correct key is inserted, it lifts the pins to the proper height, allowing the plug to turn and release the lock. Wrong keys will not lift the pins correctly, preventing the plug from rotating.

In an embodiment, the meta-lock may comprise a set of pins, each set of pins consisting of a pin comprising a set of detached segments, a driver pin, and multiple security pins. Each set of pins is also made up of a set of detached segments such as a stack of plates 304 with aligned cutouts 312. A mechanically controlled rod 302 may be configured to interface with the detached segments and to selectively bind at least one of the detached segments so as to create a shear line between the bound segment and the unbound segments. In an embodiment, the rod passes through the cutout to a desired depth and engages at that depth, for example, with an integrated structure that engages by rotating the rod about its axis.

The rod is mechanically controlled and engages a detached segment at the desired depth to create a shear line 308. The shear line refers to the point where the pins align within the lock's cylinder, allowing it to rotate and unlock or lock. The plates interlock such that the plates below the shear line 308 do not separate 310 but move as a unit. In another example, a threaded bolt is mechanically controlled and engages plates at the desired depth to create a shear line 308. In a nonlimiting example, an engagement element such as a catch 306 engages with a corresponding catch hole to interlock the plates. Although only one plate is shown and described here for the sake of clarity of the description, in embodiments, a meta-lock may comprise one or more plates, in which case, all the plates adopt the same structure.

In embodiments, the meta-lock may comprise a microprocessor actuator to actuate including but not limited to the rod, the plates and the pins as described herein. For example, a microprocessor actuator may be a device that controls an actuator (a component that converts energy into movement or action) using a microprocessor. A microprocessor, for instance, may be an integrated circuit that performs operations, such as arithmetic and logic operations, data processing, and control of other computer components. A microprocessor may include components such as the arithmetic logic unit (ALU), which performs mathematical and logical operations, and the control unit (CU), which manages the execution of instructions. This allows for more precise and flexible control of the actuator's movement and operation. In some examples, executing the specially purposed pinning instruction received by meta-lock causes the microprocessor to perform the actuations including but not limited to rotation and/or annular movement of the rod, vertical, horizontal and/or angular movement of the plates and engagement of engagement elements.

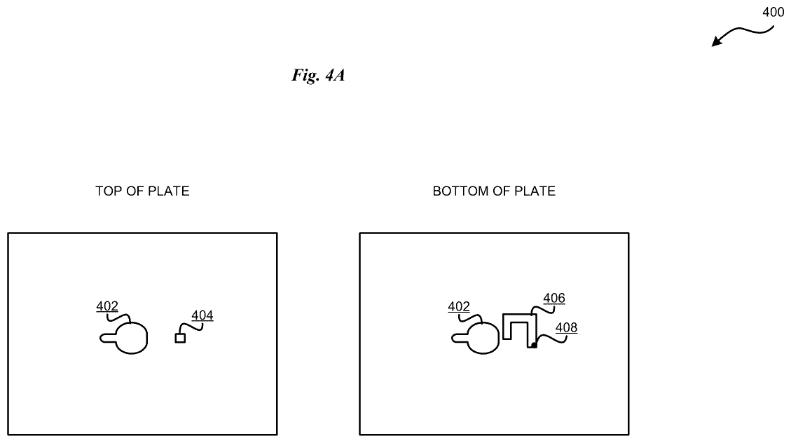

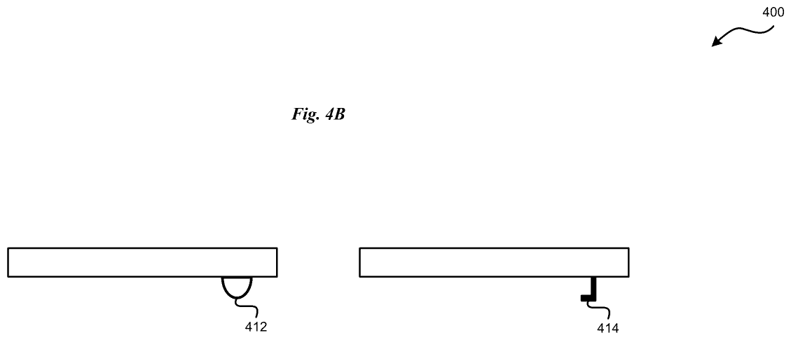

FIG. 4A depicts diagrams of a top view of a plate and bottom view of a plate of a meta-lock in accordance with an illustrative embodiment. In a particular embodiment, the components of the diagram 400 show aspects of the Application 200 of FIG. 1.

In the illustrated embodiment, a bottom view of a plate may comprise a central hole 402 and a catch hole 404. In some examples, a side of the central hole 402, for instance the left side as shown, may allow an engagement element to pass through. In an embodiment, a top of a plate may comprise a central hole 402 with a pass through for a catch 406 of an engagement element 408.

FIG. 4B depicts diagrams of side views of a plate of a meta-lock in accordance with an illustrative embodiment. In a particular embodiment, the components of the diagram 400 show aspects of the Application 200 of FIG. 1.

In the illustrated embodiment, a side view of a plate of a meta-lock shows an engagement mechanism comprising two complementary engagement elements. For example, the catch 412 such as a circular element receives a hook 414 to enable two plates of the meta-lock to engage. It should be noted that other types of engagement mechanisms of the plates may be substituted for those depicted in FIGS. 4A and 4B including but not limited to magnets, fasteners, latches, spring-loaded mechanisms, clamps or similar.

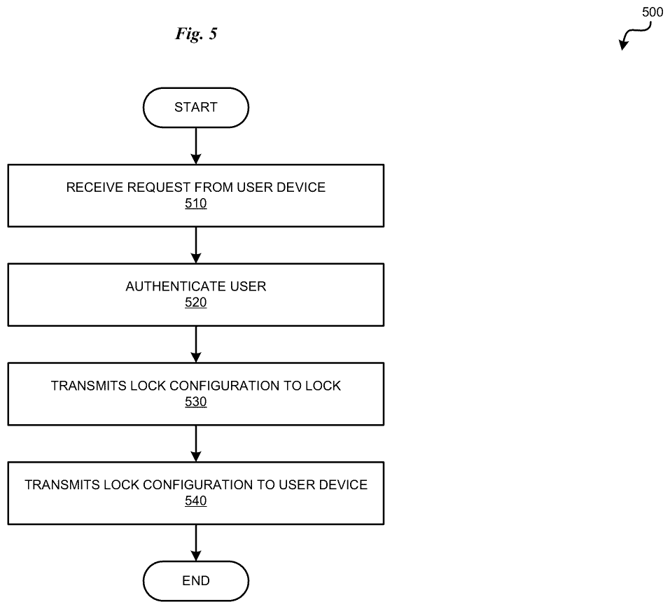

FIG. 5 depicts flow chart of configuring adaptive meta-locks and meta-keys in a network environment in accordance with an illustrative embodiment. In a particular embodiment, the components of the diagram 500 show aspects of the Application 200 of FIG. 1.

In the illustrated embodiment, the flow chart begins with a server receiving a request from a user device 510. For example, a server receives an authorization request from a user of a user device over a communication network. Responsive to receiving the request, the server authenticates the user at step 520 for authorization to unlock a meta-lock. The user may be authenticated by known methods such as a password manager, magic links, passkey, an unlock code, and/or biometrics, etc. In an example, authenticating the user comprises an authenticating method selected from a location requirement of the user device, a biometric requirement of the user, a software passkey operated on the user device, a one-time authentication code, and a security key fob in communication with the user device.

At step 530, the server transmits and sends a lock configuration to a meta-lock. In embodiments, a lock configuration may be a pinning configuration that is generated by executing a specially purposed lock configuration instruction by a lock configuration component of the server based on the key configuration included in the authorization request received from the user device. For example, a key configuration may comprise a description of a pre-existing key(s). In another example, a key configuration may comprise an image of a key.

In an embodiment, the meta-lock may be a pin-tumbler lock that comprises a set of movable plates where the lock configuration instruction is specially purposed to generate a pinning configuration adopted by the meta-lock such that a set of plates, an engagement element and/or a rod of the meta-lock are actuated. In an example, the lock server sends to the meta-lock a specially purposed pinning instruction, executing the specially purposed pinning instruction by the meta-lock causes the meta-lock to adopt the generated pinning configuration. In another example, the pinning instruction is specially purposed such that execution of the instruction by the meta-lock applies a time condition to the meta-lock such that the meta-key is usable during a period of time and for a number of uses according to the time condition.

At step 540, the server transmits and sends a lock configuration to a user device. In embodiments, a specially purposed user instruction is sent by the server to the user device, where executing the specially purposed user instruction by the user device causes a physical meta-key to be configured according to the key configuration and where the user is authorized to unlock the meta-lock with the configured physical meta-key. In an example, the specially purposed user instruction comprises an instruction by a key configuration device to produce the physical meta-key according to a key production process such as on-the-fly resin printing, injection molding or a self-configuring key blank. A key configuration device for instance, may be a locksmith device, a 3D pen and/or similar devices cut, mold, manipulate and/or transform a key blank into a meta-key.

In some embodiments, the specially purposed pinning instruction instructs the meta-lock to adopt a non-operative state wherein no key will unlock the meta-lock, the non-operative state being in the absence of an authorization request by the user. For example, executing the specially purposed pinning instruction by a meta-lock aligns its pins so that no key (and therefore no picking procedure) can create a shear line—entry is only possible by reconfiguring the lock or by destructive methods.

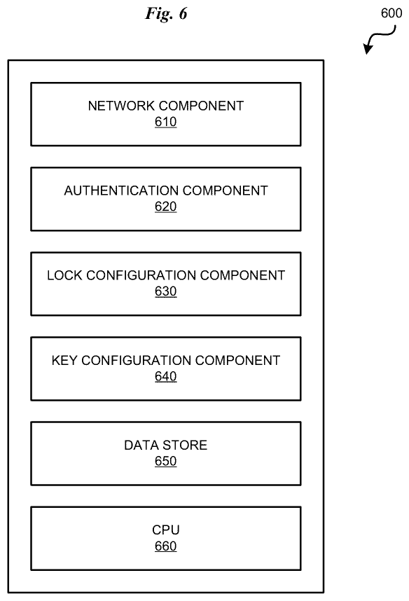

FIG. 6 depicts a system diagram for configuring adaptive meta-locks and meta-keys in a network environment in an environment in accordance with an illustrative embodiment. In a particular embodiment, the components of the diagram 600 show aspects of the Application 200 of FIG. 1.

In the illustrated embodiment, the system may comprise a network component 610, an authentication component 620, a lock configuration component 630, a key configuration component 640, a data store 650, and a central processing unit (CPU) 660.

In some embodiments, the server is installed locally on a microprocessor located at or in the meta-lock and communicates over local wireless, such as Wireless Fidelity (WIFI) directly with the user device. This setup for example, guarantees the user is physically proximate, also no infrastructure or ongoing costs are needed.

In various embodiments, the server operates in-whole or in-part from one or more processors embedded in the meta-lock, or in-whole or in-part from one or more remotely located processors, cloud services, or virtual machines; in such embodiments, the lock configuration component may be deemed to be part of the server, regardless of the particular network architecture of the embodiment.

In these embodiments, the server may issue to the microprocessor of the meta-lock, a specially purposed pinning instruction, executing the specially purposed pinning instruction by the microprocessor of the meta-lock activates a microprocessor actuator to actuate including but not limited to the rod, the plates and the pins as described herein. For example, a microprocessor actuator may be a device that controls an actuator (a component that converts energy into movement or action) using a microprocessor. A microprocessor, for instance, may be an integrated circuit that performs operations, such as arithmetic and logic operations, data processing, and control of other computer components. A microprocessor may include components such as the arithmetic logic unit (ALU), which performs mathematical and logical operations, and the control unit (CU), which manages the execution of instructions. This allows for more precise and flexible control of the actuator's movement and operation. In some examples, executing the specially purposed pinning instruction received by meta-lock causes the microprocessor to perform the actuations including but not limited to rotation and/or annular movement of the rod, vertical, horizontal and/or angular movement of the plates and engagement of engagement elements.

The server may comprise a communication component for receiving a data stream or receiving instructions that interfaces with a network adaptor, a socket, processor buses, a graphics card, one or more routers, switches, hubs, and/or other network connectivity devices. The communication component may transmit and/or receive data via network links such as data may be transmitted and/or received using Wireless Application Protocol (WAP), Multimedia Messaging Service (MMS), Enhanced Messaging Service (EMS), Short Message Service (SMS), fifth generation (5G), Long Term Evolution (LTE), Global System for Mobile Communications (GSM) based systems, Code Division Multiple Access (CDMA) based systems, Transmission Control Protocol/Internet Protocols (TCP/IP), or other protocols and/or systems suitable for transmitting and receiving data. Data may be transmitted and/or received wirelessly or may utilize cabled network connections or telecom connections such as an Ethernet RJ45/Category 5 Ethernet connection, a fiber connection, a traditional phone wireline connection, a cable connection or other wired network connection.

A physical data storage device is the underlying technology behind a data store. The data store may comprise formats such as files, tables, or blocks stored on a device. The device can be local, remote, or in the cloud. Large data stores are typically distributed across multiple physical devices in different geographic locations. Software systems and services abstract the underlying operations of the data store. Different types of data storage devices provide varying degrees of security and redundancy. A solid-state drive (SSD) is a semiconductor technology that allows the writing and reading of data in flash memory chips. Flash storage technology was commercially available in pen drives before becoming an alternative to hard disk drives (HDD). Compared to an HDD, a physical SSD has no moving parts, which means it has faster performance and a longer lifespan. Hybrid storage array is a physical storage setup that consists of an SSD and an HDD. While an SSD offers a low-latency operation, it costs much more per-unit storage than an HDD. Therefore, organizations use a hybrid storage array to balance performance, capacity, and cost. RAID stands for a redundant array of independent disks. It is a technology that keeps the same data in multiple places on an SSD.

In some embodiments, the data store stores a persistent attribute of a credential. Database persistence is the process of storing data in a way that allows it to be retrieved later, even after the application that created it has closed. This ensures that data remains accessible, reliable, and intact. Data is written to non-volatile storage, which can retain information long-term. Non-volatile storage can include hard disk drives (HDDs), cloud storage, or other storage devices. Persistent data can be accessed and updated across multiple transactions.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, computer implemented methods, and system or apparatus, are provided in the illustrative embodiments for managing participation in online communities and other related features, functions, or operations. Where an embodiment or a portion thereof is described with respect to a type of device, the computer implemented method, system or apparatus, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
responsive to receiving, by a server, an authorization request from a user of a user device for unlocking a meta-lock;
authenticating, by the server, the user for authorization to unlock the meta-lock;
generating, by the server, a key configuration;
generating, by the server, a pinning configuration based on the key configuration; and
adopting, by the meta-lock, the generated pinning configuration.

2. The computer-implemented method of claim 1, wherein the meta-lock comprises at least one pin comprising a set of detached segments wherein the meta-lock adopts the pinning configuration by selectively binding at least one of the detached segments from the set of detached segments creating a shear line between a bound segment and an unbound segment.

3. The computer-implemented method of claim 1, further comprising causing, by the user device, a physical meta-key to be configured according to the key configuration such that the physical meta-key is configured to unlock the meta-lock.

4. The computer-implemented method of claim 1, wherein the server receives from the user, the key configuration of a pre-existing key, causing the meta-lock to adopt the generated pinning configuration based on the key configuration of the pre-existing key.

5. The computer-implemented method of claim 3, further comprising producing the physical meta-key according to a key production process selected from a group consisting of on-the-fly resin printing, injection molding and a self-configuring key blank.

6. The computer-implemented method of claim 1, wherein authenticating, by the server, the user, comprises an authenticating method selected from a group consisting of a location of the user device, a biometric of the user, a software passkey operated on the user device, a one-time authentication code, and a security key fob in communication with the user device.

7. The computer-implemented method of claim 1, further comprising applying a time condition to the meta-lock such that a physical meta-key is usable during a period of time or for a number of uses, according to the time condition.

8. A computer-implemented method comprising:
responsive to receiving, by a server, an authorization request from a user of a user device for unlocking a meta-lock wherein the authorization request includes a key configuration of a pre-existing key;
authenticating, by the server, the user for authorization to unlock the meta-lock;
generating, by the server, a pinning configuration based on the key configuration; and
adopting, by the meta-lock, the generated pinning configuration.

9. The computer-implemented method of claim 8, wherein the meta-lock comprises at least one pin comprising a set of detached segments wherein the meta-lock adopts the pinning configuration by selectively binding at least one of the detached segments from the set of detached segments creating a shear line between a bound segment and an unbound segment.

10. The computer-implemented method of claim 8, further comprising causing, by the user device, a physical meta-key to be configured according to the key configuration such that the physical meta-key is configured to unlock the meta-lock.

11. The computer-implemented method of claim 8, wherein the meta-lock adopts a non-operative state wherein no key will unlock the meta-lock, the non-operative state being in absence of an authorization request by the user.

12. The computer-implemented method of claim 10, further comprising producing the physical meta-key according to a key production process selected from a group consisting of on-the-fly resin printing, injection molding and a self-configuring key blank.

13. The computer-implemented method of claim 8, wherein authenticating, by the server, the user, comprises an authenticating method selected from a group consisting of a location of the user device, a biometric of the user, a software passkey operated on the user device, a one-time authentication code, and a security key fob in communication with the user device.

14. The computer-implemented method of claim 8, further comprising applying a time condition to the meta-lock such that a physical meta-key is usable during a period of time or for a number of uses, according to the time condition.

15. A system comprising:
a meta-lock comprising at least one pin comprising a set of detached segments, and a rod wherein the rod engages a detached segment from the set of detached segments;
a processor and one or more computer readable storage media, and program instructions collectively stored on the one or more computer readable storage media, the program instructions executable by the processor to cause the processor to perform operations comprising:
responsive to receiving, by a server, an authorization request from a user of a user device for unlocking a meta-lock;
authenticating, by the server, the user for authorization to unlock the meta-lock;
generating, by the server, a key configuration;
generating, by the server, a pinning configuration based on the key configuration; and
adopting, by the meta-lock, the generated pinning configuration.

16. The system of claim 15, wherein the pinning configuration instructs the rod of the meta-lock to selectively bind at least one of the detached segments creating a shear line between a bound segment and an unbound segment.

17. The system of claim 15, further comprising causing, by the user device, a physical meta-key to be configured according to the key configuration such that the physical meta-key is configured to unlock the meta-lock.

18. The system of claim 15, wherein the server receives from the user, the key configuration of a pre-existing key, causing the meta-lock to adopt the generated pinning configuration based on the key configuration of the pre-existing key.

19. The system of claim 17, further comprising producing the physical meta-key according to a key production process selected from a group consisting of on-the-fly resin printing, injection molding and a self-configuring key blank.

20. The system of claim 15, further comprising applying a time condition to the meta-lock such that a physical meta-key is usable during a period of time or for a number of uses, according to the time condition.
